(19) United States
(12) Patent Application Publication
(10) Pub. No.: US 2011/0168098 A1
(43) Pub. Date: Jul. 14, 2011

(54) COPULSATION MILKING SYSTEM

(76) Inventors: Lanny Gehm, Lisle, NY (US); William Gehm, Lisle, NY (US)

(21) Appl. No.: 12/685,730

(22) Filed: Jan. 12, 2010

(51) Int. Cl. A01J 5/14; A01J 5/02

(52) U.S. Cl. 119/14.25; 119/14.28

(57) ABSTRACT

There is provided a method for improving the reliability and performance of a valve device that transitions between the pressure and vacuum phases for the purpose of milking animals. The improvement reduces physical wear of the movable parts within the valve device while ensuring proper function of said movable parts.

### BACKGROUND OF THE INVENTION

1. Field of the Invention

The present invention pertains to an improvement of a milking system for domesticated animals and, more particularly to a milking system with two independent valves for alternating between the pressurizing and vacuum cycles of the teat cup, as well as electronic controls for independently actuating the atmospheric pressure and vacuum cycles.

2. Description of Related Art

Typical milking systems apply periodic alternating pressure to the teat cup of a milking apparatus. This results in the removal and the flow of milk from the udder to which the teat cup is applied. The alternating pressure between the atmospheric pressure and vacuum cycles is controlled by a two-way valve combination that feeds a pulsation chamber. Conventional pulsator designs incorporate a sealing feature at both ends to provide proper function for minimizing air or vacuum leakage. This valving apparatus is commonly referred to as a pulsator.

The typical milking system integrates the pulsator with a teat cup and claw. The teat cup contains an inflatable liner that, when alternately pressurized and depressurized, causes the udder to release its milk. The milk then flows into the claw, which comprises a hollow chamber that serves as the collection unit for a plurality of teat cups. Milk gathered by the claw is then transported to a series of hoses and pipes, terminating at a storage tank.

U.S. Pat. No. 5,697,325 discloses a milking system including a valve design with controlling electronics to solve known milking performance problems with conventional milking systems. The milking system of U.S. Pat. No. 5,697,325 features two independent solenoids for control of vacuum and atmospheric pressure. The solenoid valve plunger in each of the two independent solenoids moves up and down in the center of the solenoid and has a seal at one end to minimize air or vacuum leakage when in the closed position. The other end of the valve plunger is rigid and ideally has a tapered end for maximum magnetic strength to aid in lifting the valve plunger.

The typical conventional pulsator incorporates solenoid valves with valve plungers that have seals at each end. A seal is required at each end to enable those designs to control air or vacuum at each end instead of only at one end for the milking system in U.S. Pat. No. 5,697,325.

The rigid end feature of the milking system described in U.S. Pat. No. 5,697,325 causes physical wear of the impacting surfaces of the solenoid valve plunger and the interior surface of the solenoid against which the valve plunger contacts at the end of its travel. This impact also creates unnecessary noise.

U.S. Pat. No. 4,011,838 describes a conventional pulsator design that incorporates a spring feature at one end of the solenoid valve plunger. The device described in that patent states that the purpose of the spring is to close an aperture with the valve plunger. Springs are known to be used in prior art for solenoid valves in other industries to provide a biasing means against a force impeding the movement of the valve plunger. The valve plunger utilized in the pulsator described in U.S. Pat. No. 5,697,325 utilizes the force of gravity to move the plunger as there is no biasing force to impede the movement of the valve plunger as is the case in other solenoid valves.

The present invention improves the design of the conventional pulsator by adding a compressible member between the two rigid surfaces of the solenoid valve plunger and the solenoid.

### SUMMARY OF THE INVENTION

An improved milking system that features a compressible means of limiting travel of a solenoid valve plunger. The system comprises a two-valve control that provides a sharp transition between the alternating air pressure and vacuum that are supplied to a teat cup. One valve of the pulsator mechanism controls the vacuum inlet; the other valve controls the atmospheric air inlet. Each valve device has a seal at one end and a compressible member between the valve device and the solenoid valve stopping feature. The compressible material provides a means of reducing the impact and associated noise.

### BRIEF DESCRIPTION OF THE DRAWING

FIG. 1 shows a schematic diagram of the pulsation apparatus of this invention.

FIG. 2 illustrates a schematic diagram of an alternate embodiment of the present invention.

### DETAILED DESCRIPTION OF THE INVENTION

The invention pertains to a milking system having a pulsator unit that has separate pressure and vacuum channels. Each channel is controlled by its own respective valve. The first valve of channel A controls the vacuum inlet, controlling the supply of a vacuum to a teat-cup of a milking apparatus. The second valve of channel B controls the atmospheric air inlet and air pressure to a teat cup of a milking apparatus. The electronics actuating the valves creates a sharp transition in the pulsator outlet between the atmospheric air and the vacuum, so that the vacuum and atmospheric air sources are never simultaneously connected.

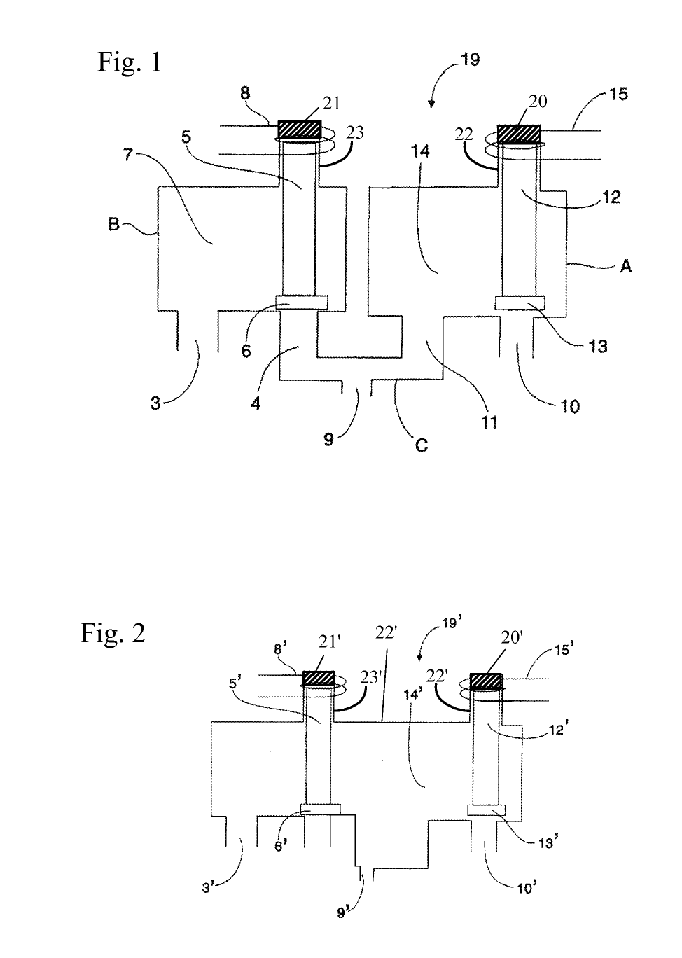

Referring to FIG. 1, a pulsator 19 includes three channels, A, B and C, with channel A controlling the vacuum inlet 10, and channel B controlling the atmospheric air pressure inlet 3. Channel A has a chamber 14, and channel B has a chamber 7. Chamber 14 has a vacuum pressure outlet 11 and a vacuum pressure inlet 10. Chamber 7 comprises an atmospheric air pressure outlet 4 and an atmospheric air pressure inlet 3.

Received within chamber 14 of channel A and solenoid housing 22 is a compressible member 20 and a biased solenoid valve plunger 12, forming a first valve. An end of the biased solenoid valve plunger 12 has a seal 13 and is biased against vacuum pressure inlet 10 in chamber 14. A solenoid coil 15 is actuated to move the solenoid valve plunger 12 against its biasing, in order to open vacuum pressure inlet 10.

Received within chamber 7 of channel B and solenoid housing 23 is a compressible member 21 and a biased solenoid valve plunger 5, forming a second valve. An end of the biased solenoid valve plunger 5 has a seal 6 and is biased against atmospheric air pressure outlet 4. A solenoid coil 8 is actuated to move the solenoid valve plunger 5 against its biasing, in order to open atmospheric air pressure outlet 4. The atmospheric air pressure outlets 4 and vacuum pressure outlet 11 open upon third channel (channel C), having outlet 9.

A control circuit (not shown) actuates either the solenoid valve plunger 12 biased against the vacuum pressure inlet 10 in chamber 14 or the solenoid valve plunger 5 biased against the atmospheric air pressure outlet 4 to open. The control circuit would ensure that only one of the valves is open at any one given time, i.e. only one of the respective solenoid valve plungers 5, 12 is lifted at any given time. This prevents the pulsator output 9 in channel C from being simultaneously connected to both the atmospheric air pressure inlet 3 of the channel B and the vacuum pressure inlet 10 of channel A.

The ends of the biased solenoid valve plungers 5, 12 that are received by the compressible member 20, 21 may be flat as shown in FIG. 1 or have a tapered or pointed end to allow for gentler cushioning.

The compressible member 20, 21 may be a spring or a resilient elastomeric material that limits the impact of the biased solenoid valve plunger 5, 12 such as room temperature vulcanizing rubber or room temperature vulcanizing silicon. Alternatively, the compressible member 20, 21 may be c-clip with a compressible washer that is received within a machine cut groove of the biased solenoid valve plunger located above either seal 6 or seal 13.

By providing a compressible member 20, 21 between the solenoid housing 22, 23 of the pulsator and the biased solenoid valve plunger 5, 12, there is a decrease in the wear of the solenoid valve plunger 5, 12 and the impact noise of the solenoid valve plunger 5, 12 with the housing 22. In other words, the compressible member 20, 21 is a resilient stop for the biased solenoid valve plunger 5, 12. Furthermore, the compressible member 20, 21 may provide stored energy to aid in moving the biased solenoid valve plunger 5, 12 towards the outlet 4, 10 after the compressible member 20, 21 has been compressed.

Now referring to FIG. 2, an alternate embodiment of the pulsator unit 19 (FIG. 1) is referred to generally as reference numeral 19′. Pulsator 19′ includes a chamber 14′. Chamber 14′ has a pressure outlet 9′ and two pressure inlets, a vacuum pressure inlet 10′ and an atmospheric air pressure inlet 3′. Received within opposite sides of the chamber 14′ in solenoid housings 22′ and 23′ are two compressible members 20′, 21′ and two biased, solenoid valve plungers 12′, 5′ forming respective first and second valves.

An end of the biased solenoid valve plunger 12′ has a seal 13′ and is biased against vacuum pressure inlet 10′ in chamber 14′. A solenoid coil 15′ is actuated to move the solenoid valve plunger 12′ against its biasing, in order to open vacuum pressure inlet 10′. Similarly, an end of the biased solenoid valve plunger 5′ has a seal 6′ and is biased against atmospheric air pressure inlet 3′. A solenoid coil 8′ is actuated to move the solenoid valve plunger 5′ against its biasing, in order to open atmospheric air pressure inlet 3′. Since, in this embodiment, the solenoid valve plunger 5′ may not have adequate sealing capability, it is desirable to provide additional sealing means, such as springs or other mechanisms known in the art.

A control circuit (not shown) actuates either the solenoid valve plunger 12′ biased against the vacuum pressure inlet 10′ in chamber 14 or the solenoid valve plunger 5′ biased against the atmospheric air pressure inlet 3′ to open. The control circuit would ensure that only one of the valves is open at any one given time, i.e. only one of the respective solenoid valve plungers 5′, 12′ is lifted at any given time. This prevents the pulsator output 9′ from being simultaneously connected to both the atmospheric air pressure inlet 3′ and the vacuum pressure inlet 10′.

The ends of the biased solenoid valve plungers 5′, 12′ that are received by the compressible member 20′, 21′ may be flat as shown in FIG. 2 or have a tapered or pointed end to allow for gentler cushioning.

The compressible member 20′, 21′ may be a spring or a resilient elastomeric material that limits the impact of the biased solenoid valve plunger 5′, 12′ such as room temperature vulcanizing rubber or room temperature vulcanizing silicon. Alternatively, the compressible member 20′, 21′ may be c-clip with a compressible washer that is received within a machine cut groove of the biased solenoid valve plunger located above either seal 6′ or seal 13′.

By providing a compressible member 20′, 21′ between the solenoid housing 22′, 23′ of the pulsator and the biased solenoid valve plunger 5′, 12′, there is a decrease in the wear of the solenoid valve plunger 5′, 12′ and the impact noise of the solenoid valve plunger 5′, 12′ with the housing 22. In other words, the compressible member 20′, 21′ is a resilient stop for the biased solenoid valve plunger 5′, 12′. Furthermore, the compressible member 20′, 21′ may provide stored energy to aid in moving the biased solenoid valve plunger 5′, 12′ towards the outlet 4′, 10′ after the compressible member 20′, 21′ has been compressed.

Accordingly, it is to be understood that the embodiments of the invention herein described are merely illustrative of the application of the principles of the invention.

Reference herein to details of the illustrated embodiments is not intended to limit the scope of the claims, which themselves recite those features regarded as essential to the invention.

What is claimed is:

1. A milking apparatus for providing pressure and vacuum phases of a pulsator mechanism, comprising:
a pulsator comprising a first valve and a second valve, the first and second valves each having a solenoid housing with a respective inlet and a respective outlet through which air pressure and vacuum can be respectively supplied to a teat-cup milking apparatus, the first valve and second valve each comprising a biased solenoid valve plunger and a compressible member between an end of the biased solenoid valve plunger and the solenoid housing;
a first valve control for controlling the supply of air pressure to said teat-cup milking apparatus;
a second valve control for controlling the supply of a vacuum to said teat-cup milking apparatus;
a common outlet operatively connected to both of said valves through which air pressure and vacuum are alternately supplied to said teat-cup milking apparatus from said first and second valves, respectively; and
control means connected to said first and second valve controls, said control means respectively actuating and deactivating said first and second valve controls to provide alternating supply of air pressure and vacuum to said common outlet, with said first and second valve controls never being simultaneously actuated.

2. The milking apparatus of claim 1, wherein the compressible member is a spring, room temperature vulcanizing silicon, room temperature vulcanizing rubber, or a c-clip and washer.

3. The milking apparatus of claim 1, wherein an end of the biased solenoid valve plunger is tapered.

4. An improved milking apparatus for providing pressure and vacuum phases of a pulsator mechanism, comprising: a pulsator comprising a first valve and a second valve, the first and second valves each having a respective inlet and a respective outlet through which air pressure and vacuum can be respectively supplied to a teat-cup milking apparatus, the first valve and second valve each having a solenoid housing comprising a biased solenoid valve plunger; a first valve control for controlling the supply of air pressure to said teat-cup milking apparatus; a second valve control for controlling the supply of a vacuum to said teat-cup milking apparatus; a common outlet operatively connected to both of said valves through which air pressure and vacuum are alternately supplied to said teat-cup milking apparatus from said first and second valves, respectively; and control means connected to said first and second valve controls, said control means respectively actuating and deactivating said first and second valve controls to provide alternating supply of air pressure and vacuum to said common outlet, with said first and second valve controls never being simultaneously actuated, the improvement comprising:
a compressible member between an end of the biased solenoid valve plunger and the solenoid housing of the first valve and the second valve.

5. The improved milking apparatus of claim 4, wherein the compressible member is a spring, room temperature vulcanizing silicon, room temperature vulcanizing rubber, or a c-clip and washer.

6. The improved milking apparatus of claim 4, wherein an end of the biased solenoid valve plunger is tapered.

7. A solenoid comprising:
a housing defining a bore;
a valve plunger slidably received within the bore of the housing
a biasing means for biasing the valve plunger into the bore of the housing; and
a compressible member between an end of the valve plunger and the bore of the housing.

8. The solenoid of claim 7, wherein the compressible member is a spring, room temperature vulcanizing silicon, room temperature vulcanizing rubber, or a c-clip and washer.

9. The solenoid of claim 7, wherein an end of the biased solenoid valve plunger is tapered.
